(19) United States
(12) Patent Application Publication
(10) Pub. No.: US 2008/0134801 A1
(43) Pub. Date: Jun. 12, 2008

(54) TACTILE SENSING DEVICE FOR HUMAN ROBOT INTERACTION AND METHOD THEREOF

(75) Inventors: Kuo-Shih Tseng, Taichung County (TW); Chiu-Wang Chen, Changhua County (TW); Yi-Ming Chu, Kaohsiung County (TW); Wei-Han Wang, Taipei County (TW); Hung-Hsiu Yu, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/617,733

(22) Filed: Dec. 29, 2006

(30) Foreign Application Priority Data
Nov. 22, 2006 (TW) 95143158

(51) Int. Cl. G01D 7/00

(52) U.S. Cl. 73/862.041

(57) ABSTRACT

A tactile sensing for human robot interaction device and a method thereof are provided. The tactile sensing device at least includes a touch interface, a tactile sensor module, a controller, and an actuating unit. The tactile sensor module coupled to the touch interface is used to sense an external touch, so as to generate a series of timing data corresponding to the external touch. The controller coupled to the tactile sensor module is used to receive the series of timing data, and to determine a touch pattern based on a geometric calculation, so as to generate a control signal. The actuating unit coupled to the controller responses an interactive reaction corresponding to the touch pattern based on the control signal.

### CROSS-REFERENCE TO RELATED APPLICATION

This application claims the priority benefit of Taiwan application serial no. 95143158, filed on Nov. 22, 2006. All disclosure of the Taiwan application is incorporated herein by reference.

### BACKGROUND OF THE INVENTION

1. Field of the Invention

The present invention relates to a device and a method for human robot interaction, and more particularly, to a device and a method of tactile sensing for human robot interaction.

2. Description of Related Art

A robot needs diversified inputs to create diversified interactions with human beings. Generally, conventional robots or entertainment toys only have an ON/OFF switch sensor or a large number of array sensors to detect a touch in a large area. Since information of system input signals is too little or too much to be calculated, a diversified human robot interaction cannot be achieved.

FIG. 1 is a schematic diagram showing a human robot interaction. The human robot interaction is achieved by sensing and analyzing to determine the external situation based on inputted information such as senses of vision, hearing, and touch, and then outputting a synthesized action. For example, as disclosed in Japanese Laid-Open Publication No. 2001-038658, the human robot interaction is achieved by using tactile sensors to sense the impedance of an actuator. Furthermore, as disclosed in Japanese Laid-Open Publication No. 2003-117256, the human robot interaction is achieved by employing a capacitance principle to enable the palpus of the device to perform preset interactive actions upon being touched by human beings. The aforementioned human robot interactions are both achieved through tactile sensors. However, the former requires a sophisticated design to achieve a preferred interaction between the actuator and the human beings, while the later only provides preset sensing modes, which makes the interaction become relatively dull. Both the above two solutions lack of diversified information, and have problems of complicated system architecture and high cost. Therefore, the two solutions need to be improved in both application and diversity.

### SUMMARY OF THE INVENTION

In view of the above problems, the present invention provides a tactile sensing device for human robot interaction and a method thereof. At least one set of tactile sensor modules is utilized, and an algorithm is utilized to calculate the timing data for determining a touch pattern, so as to sense magnitudes, ranges, and time of the touch. The device interacts with human through actions or sounds output from an actuator, speaker, or display based upon the obtained information, and thus achieving a diversified interactive solution at a low cost.

The present invention provides a tactile sensing device for human robot interaction, which at least comprises a touch interface, a tactile sensor module, a controller, and an actuating unit. The tactile sensor module coupled to the touch interface is used to sense an external touch, so as to generate a series of timing data corresponding to the external touch. The controller coupled to the tactile sensor module is used to receive the series of timing data, and to determine a touch pattern based on a geometric calculation, so as to generate a control signal. The actuating unit coupled to the controller responses an interactive reaction corresponding to the touch pattern based on the control signal.

Moreover, the present invention also provides a tactile sensing method for human robot interaction, which at least comprises the following steps. An external touch is provided on a touch interface. The external touch is sensed in a tactile sensing manner to generate a series of timing data corresponding to the external touch. A touch pattern corresponding to the external touch is calculated and determined based on a geometric calculation and the series of timing data. According to the touch pattern, an interactive reaction is synthesized and output to the external environment, so as to achieve a preferred human robot interaction.

According to the present invention, the present invention utilizes the timing data of a tactile sensor to determine a touch pattern of the device, so as to synthesize into different actions to generate human robot interactive actions. Moreover, the present invention further uses the tactile sensors and the controller of low cost to detect position changes of an area-type (two-dimensional) touch, thus achieving a multi-functional human robot interaction.

In order to make the aforementioned and other objectives, features, and advantages of the present invention comprehensible, preferred embodiments accompanied with figures are described in detail below.

### BRIEF DESCRIPTION OF THE DRAWINGS

FIG. 1 is a schematic diagram showing a relationship between an interactive reaction of a human robot interface and an external environment.

FIGS. 2 and 3 are schematic diagrams showing a relationship between a tactile sensor module and an external environment according to the present invention.

FIGS. 4A and 4B show calculation methods when the applied force is linear and non-linear.

FIG. 5 is a schematic diagram of an example of a passive tactile sensing mode.

FIG. 6 is a schematic diagram of another example of a passive tactile sensing mode.

FIG. 7 is a schematic diagram of another example of a passive tactile sensing mode.

FIG. 8 is a schematic diagram of an example of an active tactile sensing mode.

FIG. 9 is a schematic flow chart of the present invention.

FIG. 10 shows another application example of the present invention.

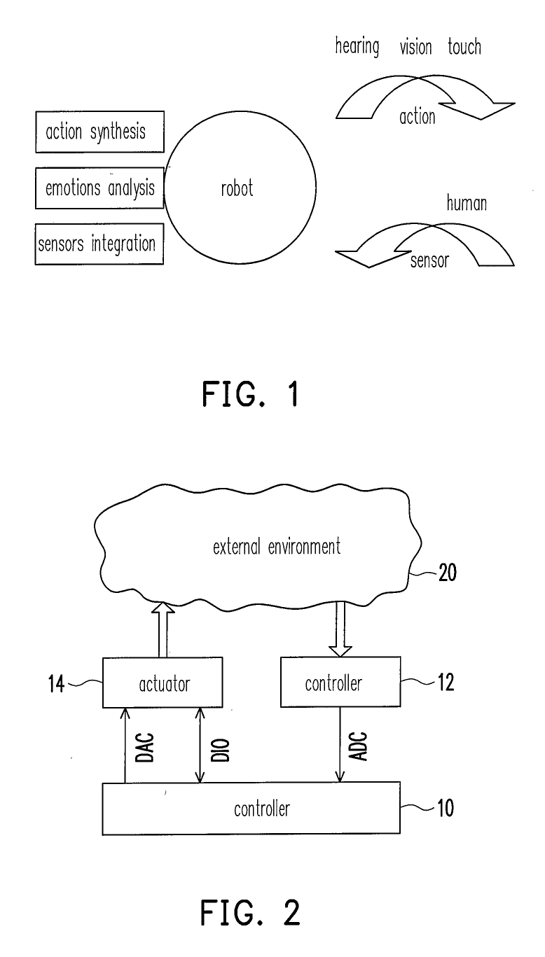

### DESCRIPTION OF EMBODIMENTS

FIG. 2 is a schematic diagram showing a tactile sensing device for human robot interaction according to one embodiment of the present invention. As shown in FIG. 2, the tactile sensing device for human robot interaction comprises a tactile sensor module 12, a controller 10, and an actuating unit 14, in which the tactile sensor module 12 is coupled to the controller 10. Moreover, the device further comprises an analog-to-digital converter (ADC) coupled between the tactile sensor module 12 and the controller 10 for performing an analog-to-digital conversion on a series of timing data. In addition, the device further comprises a digital-to-analog converter (DAC) coupled between the controller 10 and the actuating unit 14.

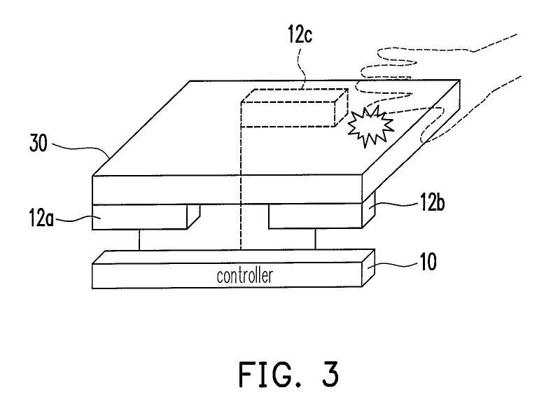

As shown in FIG. 3, the tactile sensor module 12 can be a strain gauge or a conductive rubber. The tactile sensor module 12 is mounted on a touch interface 30. The touch interface 30 provides an interface between the external (for example, human) and an interactive device (for example, a robot). The touch interface 30 can be a soft interface or a hard interface.

Furthermore, the tactile sensor module 12 can be selected as, for example, a pressure sensor, a strength sensor, a capacitance sensor, or a displacement sensor, depending on physical parameters of touch to be detected.

The tactile sensor module 12 can obtain a set of timing data Fn (fT) according to the circumstance of applying a pressure and/or a force on the touch interface 30, where f is a magnitude of the force applied to the tactile sensor module 12, and T is an acquiring time. The tactile sensor module 12 can acquire data at a time interval of Δt. The time interval Δt can be fixed or random. In order to precisely sense an area-type (two-dimensional) touch pattern on the touch interface 30, three tactile sensor modules are preferably used. Of course, the number of the tactile sensor modules used is not particularly restricted in practice.

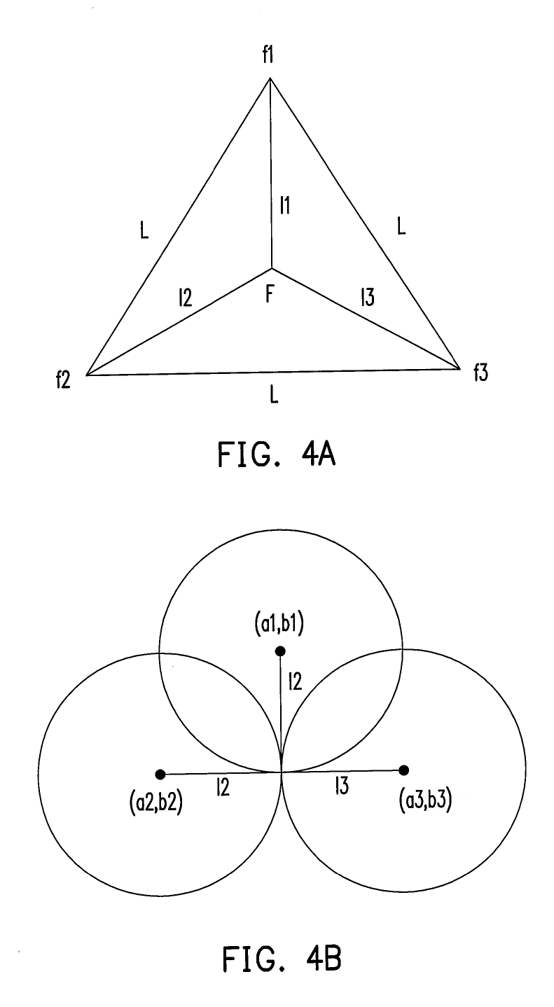

The controller 10 can acquire the data read by the tactile sensor module 12 via the ADC. Then, F (f, X, Y, T) can be obtained by, for example, a geometric calculation shown in FIGS. 4A and 4B, i.e., calculating the magnitude (f), position (X,Y), and time (T) of the applied force. In this way, the controller 10 can determine a touch pattern with the external according to continuous Fm (f, X, Y, T).

After determining the touch pattern, the controller 10 transmits a control signal to the actuator 14 via the DAC based on the determined touch pattern. Thus, the actuator 14 responses an interactive reaction corresponding to the external touch. The interactive reaction can be various actions of limbs and trunk to form interactive expressions with different speeds, positions and strengths, or to alter a structural rigidity of the limb and trunk, or to express sounds of voice, music, and pre-recording by a speaker; or to display images, characters, colors, brightness, blink, and graphs on a display device.

Next, FIGS. 4A and 4B show calculation methods when the applied force is linear and non-linear, i.e., illustrating the method for calculating F (f,X,Y,T). The following illustration is divided into two cases: (1) the force applied to the sensing module has a linear relationship with the distance; and (2) the force applied to the sensing module has a non-linear relationship with the distance. In the case of the non-linearity, the calculations can be accelerated by using a look-up table. In the embodiment, it is described by a triangular positioning method. The case that the applied force is linear with the distance is described first.

As shown in FIG. 4A, it is assumed that f₁, f₂, f₃ are magnitudes (readings) of the applied force respectively sensed by tactile sensors 12a, 12b, 12c, and l₁, l₂, l₃ are distances from the tactile sensors 12a, 12b, 12c to the point of the force application. The magnitude of the force applied from the external (for example, human) to a touch position on the touch interface 30 is F, i.e., the actual touch force from the external. Since the applied force and the distance form a linear relationship, the force f1 is inversely proportional to l₁, and the magnitudes of the applied forces respectively sensed by the tactile sensors 12a, 12b, 12c can be represented by the following formulas.

fₙ∝1/lₙ, where n=1, 2, 3 (1)

fₙ×lₙ/K=F, where K is a constant (2)

In this example, three tactile sensors 12a, 12b, and 12c are used for explanation, which are respectively disposed at vertexes of a triangle with a side length of L.

It is assumed that the acquiring retrieve time T is Δt, and the readings of the three sensing modules 12a, 12b, and 12c are f₁, f₂, and f₃ respectively. The following results can be obtained from above formulas (1) and (2). The ratio of the constants a:b:c can be derived from the readings f₁, f₂, and f₃, and H is a proportional constant.

f₁:f₂:f₃=1/l₁:1/l₂:1/l₃

l₁:l₂:l₃=a:b:c

l₁=aH, l₂=bH, l₃=cH (3)

Next, three circle equations are obtained below by taking positions of the tactile sensors 12a (a₁, b₁), 12b (a₂, b₂), and 12c (a₃, b₃), as the circle centers and the respective distances to the stress point l₁, l₂, and l₃ as the radii.

(X−a₁)²+(Y−b₁)²=l₁²

(X−a₂)²+(Y−b₂)²=l₂²

(X−a₃)²+(Y−b₃)²=l₃² (4)

From the above formulas (3) and (4), three intersection lines with the thress circles can be calculated as follows. Moreover, unknown numbers X, Y, and H can be obtained from the formulas below.

(2a₂−2a₁)X+(2b₂−2b₁)Y=l₁²−l₂²=(a²−b²)H²

(2a₃−2a₂)X+(2b₃−2b₂)Y=l₂²−l₃²=(b²−c²)H²

(2a₁−2a₃)X+(2b₁−2b₃)Y=l₃²−l₁²=(c²−a²)H² (5)

Then, when T=Δt and the touch position is (X,Y), the magnitude of the touch force is calculated as F=f₁×l₁/K.

Thus, for every time interval of Δt, the magnitude and the position of the applied force can be calculated, and thereby a touch pattern on the touch interface is determined. It should be noted that the time interval Δt can be identical or not.

Next, the non-linear relationship is illustrated, and the non-linear function is expanded by Taylor's expansion for explanation. In the case of non-linearity, it is assumed that

$${f}_{1} ∝ \frac{1}{g ( {l}_{1} )} ,$$

and thus f₁×g(l₁)/K=F, where g(l₁) is a non-linear polynomial function that can be obtained through experiments. The non-linear function is expanded as follows by Taylor's expansion.

$$g ( l ) = \begin{matrix}g ( l ) + \frac{{f}^{′} ( l ) {( x - l )}^{1}}{1 !} + \frac{{f}^{″} ( l ) {( x - l )}^{2}}{2 !} + \\ \frac{{f}^{″ ′} ( l ) {( x - l )}^{3}}{3 !} + … \frac{{f}^{m} ( l ) {( x - l )}^{m}}{m !} + … \end{matrix} = \sum \frac{{f}^{m} ( l ) {( x - l )}^{m}}{m !}$$

$$for m = 0 , 1 , … ∞ .$$

As described above, the difference from the linear case only lies in

$${f}_{1} : {f}_{2} : {f}_{3} = \frac{1}{g ( {l}_{1} )} : \frac{1}{g ( {l}_{2} )} : \frac{1}{g ( {l}_{3} )} .$$

### Therefore, the magnitude and position of the force applied at the point of force application can be obtained through the aforementioned process, and the value (X,Y,F) at each time point can be obtained by repeating the above steps.

FIG. 9 is a schematic flow chart of a tactile sensing method for human robot interaction according to the present invention. At Step S100, the controller is initialized. At Step S102, a plurality of data sets of tactile sensors are acquired, i.e., Fn (f, T). Namely, the readings of the tactile sensors 12a, 12b, and 12c under an applied force F at an acquiring time T.

At Step S104, a series of timing data is calculated based on the data Fn (f, T) obtained at Step S102. For example, the magnitude F and the position (X, Y) of the force application point can be calculated at several time points through the process in FIGS. 4A and 4B, so as to obtain a series of timing data F (f, X, Y, T). The timing data can be a relationship between the magnitude F and the time T, a relationship between the position (X, Y) and the time, or a relationship among the magnitude F, the position (X, Y) and the time T, and a relationship between the position (X, Y) and the time.

Next, at Step S106, based upon the series of timing data obtained at Step S104, a touch pattern represented by the series of timing data is determined. After the touch pattern is determined, a corresponding action is synthesized and outputted at Step S108, so as to create an interactive reaction. Otherwise, if the touch pattern is hard to be determined, the data of the tactile sensors are continuously acquired.

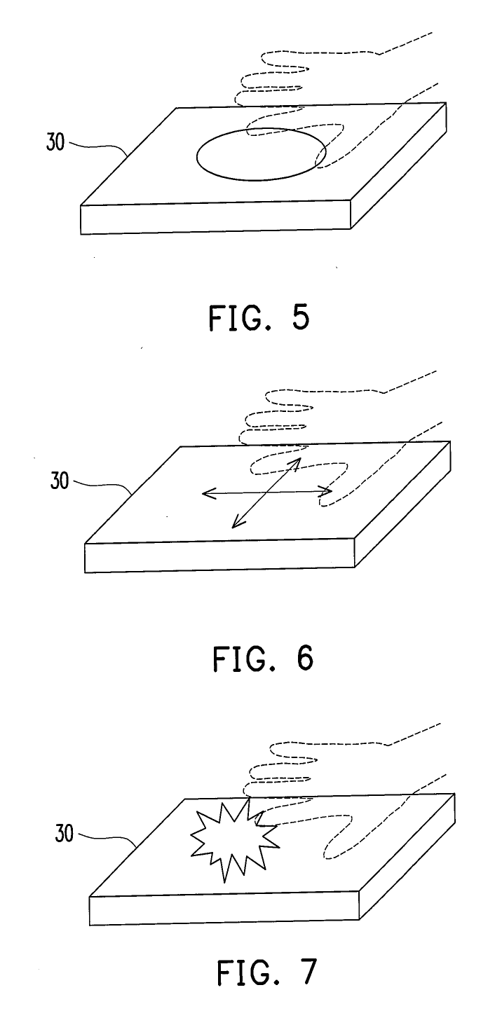

For example, after the controller 10 acquires data from the tactile sensors 12a, 12b, and 12c, the timing data at each time point can be calculated, for example, through the above process, and thereby determining the touch pattern. For example, a circular touch in FIG. 4, a back-and-forth touch along XY direction in FIG. 5, and an instant impact in FIG. 6 are all typical touch patterns. The controller 10 determines various touch patterns based on the above timing data. The above touch patterns are passive tactile sensation, which is generally referred to the sensing of a still body upon being touched by the external.

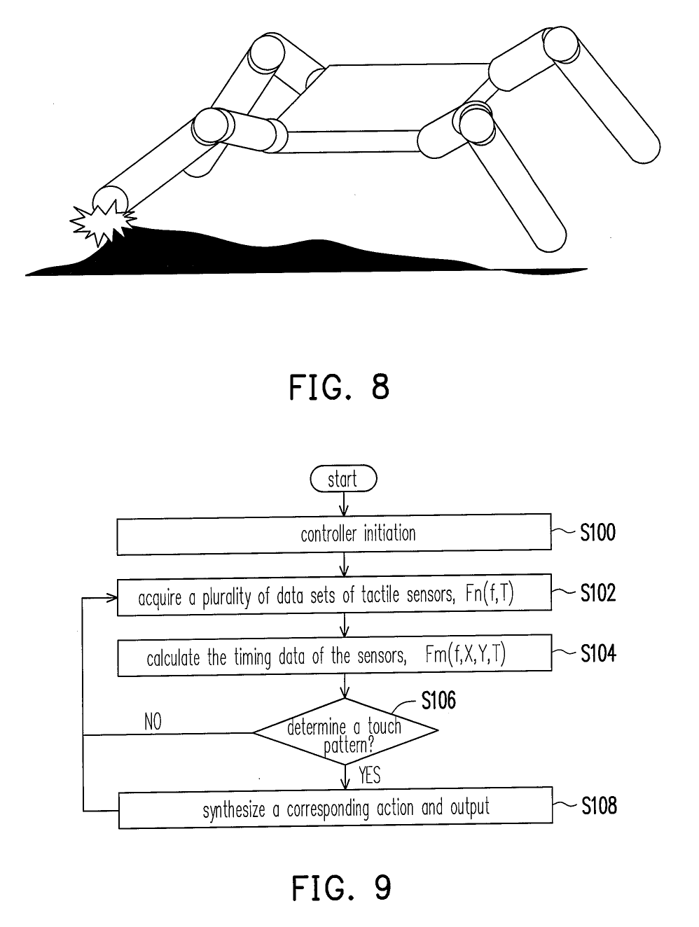

Another touch pattern is an active tactile sensing, which generally refers to that for example a robot hits an external object during its movement. For example, in FIG. 8, when a robot arm or leg hits or crashes a foreign object, the robot interacts with the external object instinctively, for example, balancing the limbs, drawing back the limbs due to reflection, and so on.

After determining the touch pattern, the controller 10 outputs a control signal to the actuator 14 accordingly, so as to enable the actuator 14 to make a proper interactive reaction to the external environment. For example, when the device (robot) is in an application that the robot head is touched as shown in FIG. 4, the robot can feel comfort and its mood gradually becomes stable. Namely, the controller 10 controls the actuator to stabilize the emotional block of the robot. Alternatively, when all the sensing modules spread all over the robot are triggered, a hug from human can be determined, so as to response an interactive reaction of stretching out the arms to hug the human. Moreover, when the robot is touched, the robot can be controlled to move along the direction of the applied force, and thus generating an interactive reaction for a guiding function.

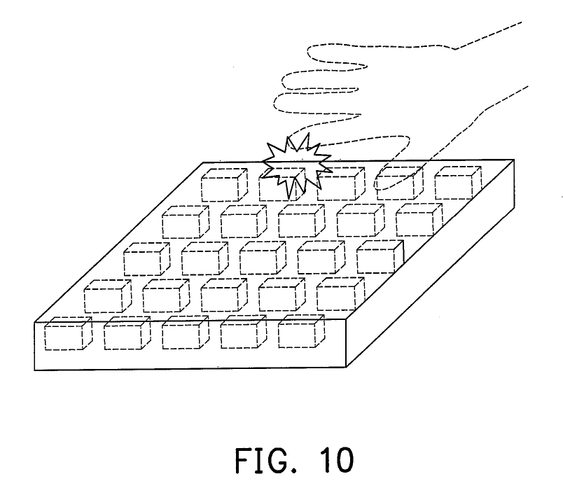

FIG. 10 shows another application example of the present invention. When the present invention is applied to sense a larger region, more tactile sensors can be mounted on the touch interface. In addition, the sensing process still can be achieved through the algorithm in FIG. 9 as long as there are three or more sensing information, and thereby achieving an effect of sensing touch pattern in a large area.

In summary, the present invention integrates the controller with the tactile sensors, and utilizes the timing data of the tactile sensors to determine a touch pattern of the device (robot), so that different behaviour actions can be synthesized and interactive actions between the human and the robot can be created. Therefore, the present invention uses tactile sensors and a controller at a low cost to detect changes of touch position in an area-type (two dimensional) manner, thus achieving a multi-functional human robot interaction.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A tactile sensing device for human robot interaction, comprising:
a touch interface;
a tactile sensor module, coupled to the touch interface, for sensing an external touch, so as to generate a series of timing data corresponding to the external touch;
a controller, coupled to the tactile sensor module, for receiving the series of timing data, and determining a touch pattern based on a geometric calculation, so as to generate a control signal; and
an actuating unit, coupled to the controller, for responsing an interactive reaction corresponding to the touch pattern based on the control signal.

2. The tactile sensing device as claimed in claim 1, wherein the series of timing data are a relationship between time and positions of force application points for the external touch.

3. The tactile sensing device as claimed in claim 1, wherein the series of timing data are a relationship between magnitudes and time for the external touch.

4. The tactile sensing device as claimed in claim 1, wherein the series of timing data are a relationship among magnitudes, positions, and time of the external touch.

5. The tactile sensing device as claimed in claim 1, further comprising:
an analog-to-digital converter (ADC), coupled between the tactile sensor module and the controller, for performing analog-to-digital conversion on the series of timing data; and
a digital-to-analog converter (DAC), coupled between the controller and the actuating unit.

6. The tactile sensing device as claimed in claim 1, wherein the touch interface is a soft interface or a hard interface.

7. The tactile sensing device as claimed in claim 1, wherein the tactile sensor module is a pressure sensor, a strength sensor, a capacitance sensor, or a displacement sensor.

8. The tactile sensing device as claimed in claim 1, wherein the tactile sensor module is constituted by at least three sensors, for detecting a two-dimensional touch pattern.

9. The tactile sensing device as claimed in claim 8, wherein the sensors are strain gauges or conductive rubbers.

10. The tactile sensing device as claimed in claim 1, wherein the touch interface is a terminal of a moving limb and trunk.

11. The tactile sensing device as claimed in claim 1, wherein the interactive reaction with the external comprises using an action of limbs and trunk to express an interaction with different speeds, positions, and strengths of forces, or to alter a structural rigidity of the limbs and trunk.

12. A tactile sensing method for human robot interaction, comprising:
providing an external touch on a touch interface;
sensing the external touch in a tactile sensing manner, so as to generate a series of timing data corresponding to the external touch;
calculating and determining a touch pattern of the external touch according to a geometric calculation and the series of timing data; and
synthesizing into an interactive reaction according to the touch pattern.

13. The tactile sensing method as claimed in claim 12, wherein the series of timing data are a relationship between positions of force application points and time for the external touch.

14. The tactile sensing method claimed in claim 12, wherein the series of timing data are a relationship between magnitudes and time for the external touch.

15. The tactile sensing method as claimed in claim 12, wherein the series of timing data are a relationship among magnitudes, positions and time for the external touch.

16. The tactile sensing method as claimed in claim 12, wherein the tactile sensing process is achieved through a pressure sensor, a strength sensor, a capacitance sensor, or a displacement sensor.

17. The tactile sensing method claimed in claim 12, wherein the tactile sensing process is to detect a two-dimensional touch pattern by at least three sensors.

18. The tactile sensing method as claimed in claim 17, wherein the sensors are strain gauges or conductive rubbers.

19. The tactile sensing method as claimed in claim 12, wherein the interactive reaction comprises using an action of limbs and trunk to express an interaction with different speeds, positions, and strengths of forces, or to alter a structural rigidity of the limbs and trunk.
